(19) United States
(12) Patent Application Publication
(10) Pub. No.: US 2005/0193960 A1
(43) Pub. Date: Sep. 8, 2005

(54) Apparatus for improving combustion efficiency of internal combustion engine

(76) Inventor: Sang Jin Lee, Seoul (KR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/941,106

(22) Filed: Sep. 15, 2004

(30) Foreign Application Priority Data
Mar. 5, 2004 (KR) 2004-15174
Aug. 4, 2004 (KR) 2004-61499

(51) Int. Cl. F02G 5/00

(52) U.S. Cl. 123/1 A

(57) ABSTRACT

Disclosed is a combustion-efficiency improving apparatus immerged into a fuel tank of an internal combustion. The apparatus includes a core rod 10 having a ceramic powder 12 coated or impregnated on an outer periphery of a silver alloy 11, and an aluminum alloy cladding the ceramic powder 12; and an internal electrode 20 enclosing an outer periphery of the core rod 10 for creating a potential difference through shifting of electrons between the internal electrode and fuel. A reduction potential of water contained in the fuel is achieved by an electromotive force and an electromagnetic wave generated from the core rod and the internal electrode. A reduction potential of the water contained in the fuel is achieved by the electromotive force and the electromagnetic wave generated from the apparatus, thereby improving the combustion efficiency of the fuel, as well as saving the fuel and minimizing the smoke.

### BACKGROUND OF THE INVENTION

1. Field of the Invention

The present invention relates to a fuel-saving apparatus for an internal combustion engine, and more particularly, to an apparatus for improving combustion efficiency of an internal combustion engine, by which moisture contained in fuel is eliminated to increase power of an operating machine and to reduce smoke due to incomplete combustion.

2. Background of the Related Art

In general, a combustion process of vehicles or boilers is implemented by forcibly injecting a liquid or a gaseous hydrocarbon into a combustion chamber. At this time, incomplete combustion results from inadequate mixing of oxygen and fuel in a burning process, since there is attraction between negative charges (electrons) and positive charges (protons).

In order to solve the incomplete combustion of the fuel in the internal combustion engine, a fuel miser has been developed to accelerate activation or ionization of the fuel, thereby improving a combustion efficiency and also minimizing smoke.

For example, there is a method of pre-heating the fuel supplied to the internal combustion engine to bring about complete combustion. Specifically, the fuel supplied to the combustion chamber is heated to vaporize the fuel, which raising pressure within the combustion chamber and accelerating the reaction with the oxygen.

In the above pre-heating method, an additional pre-heating device should be provided to heat the fuel supplied to the combustion chamber, which increases cost and also complicates construction. In addition, there is another drawback in that since most of the pre-heating device utilize electricity as a heat source, energy consumption is large. Therefore, in practice, it has not been practical to use in pre-heatingdevices.

Another method has been proposed of filtering the fuel and aligning a molecular arrangement by means of a permanent magnet provided in a fuel tank or a fuel injection path, on the basis of the fact that a permanent magnet is provided in an internal combustion engine to activate the combustion of the fuel.

However, in the method using the permanent magnet, a magnetic force is gradually decreased by vibration of the internal combustion and an electric field. If the magnetic force is decreased, the fuel is not sufficiently activated due to insufficient magnetization resulted from the improper relationship between an inflow speed of the fuel and contact of the magnet.

### SUMMARY OF THE INVENTION

Accordingly, an object of the present invention is to obviate one or more problems due to limitations and disadvantages of the related art and to provide apparatus for improving combustion efficiency of an internal combustion engine, by which moisture contained in fuel is eliminated to increase the power of an operating machine and to reduce smoke due to incomplete combustion.

To achieve the object and other advantages, according to one aspect of the present invention, there is provided a combustion-efficiency improving apparatus immerged into a fuel tank of an internal combustion, the apparatus comprising: a core rod having a ceramic powder coated or impregnated on an outer periphery with a silver alloy, and an aluminum alloy cladding the ceramic powder; and an internal electrode enclosing an outer periphery of the core rod for creating a potential difference through shifting of electrons between the internal electrode and fuel, in which a reduction potential of water contained in the fuel is achieved by an electromotive force and an electromagnetic wave generated from the core rod and the internal electrode.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a combustion-efficiency improving apparatus according to one preferred embodiment of the present invention;

FIGS. 2 through 5 are views illustrating a combustion-efficiency improving apparatus according to alternative embodiments of the present invention; and

FIG. 6 is a cross-sectional view of a combustion-efficiency improving apparatus according to one preferred embodiment of the present invention.

### DETAILED DESCRIPTION OF THE PREFERRED EMBODIMENTS

A preferred embodiment according to the present invention will now be explained with reference to the accompanying drawings

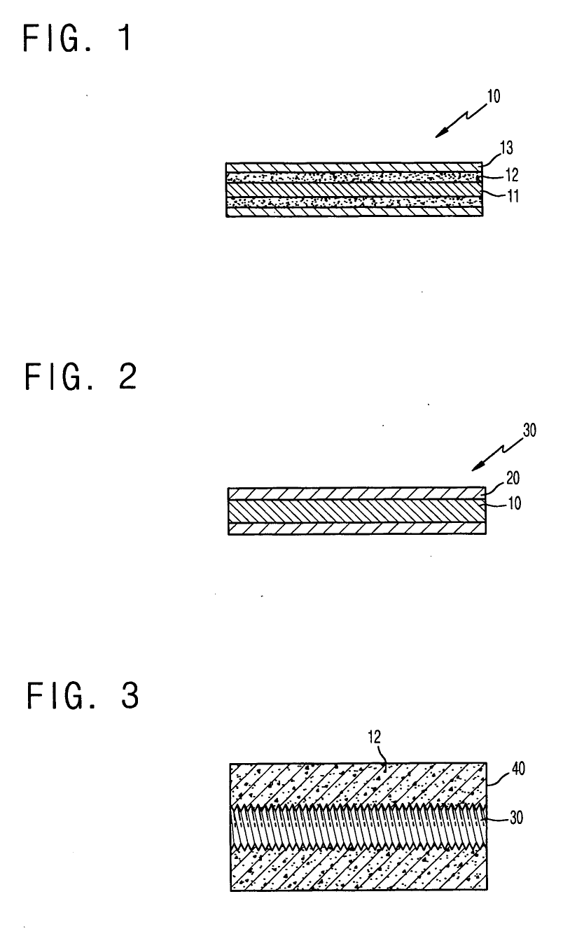

FIGS. 1 through 6 show embodiments of a combustion-efficiency improving apparatus according to the present invention. The combustion-efficiency improving apparatus is adapted to be immerged into a fuel tank of an internal combustion, and is characterized in that an internal electrode 20, an outer electrode 40, and a lateral electrode 50 are separately fixed to an outer periphery of a core rod 10, or at least one of the electrodes 20, 40 and 50 is connected to the core rod 10.

### EMBODIMENTS

### Embodiment 1

Referring to FIG. 1, the combustion-efficiency improving apparatus is adapted to be immerged to a fuel tank of an internal combustion. The apparatus includes a core rod 10 having a ceramic powder 12 coated or impregnated on an outer periphery of a silver alloy 11, and an aluminum alloy cladding the ceramic powder 12; and an internal electrode 20 enclosing an outer periphery of the core rod 10 for creating a potential difference through shifting of electrons between the internal electrode and fuel.

Specifically, the core rod 10 is enclosed by the internal electrode 20 to radiate far-infrared, as shown in FIG. 1. The core rod 10 includes the silver alloy 11 forming a core of a housing, the ceramic powder 12 coated or impregnated on the outer periphery of the silver alloy 11, and the aluminum film 13 enclosing the outer periphery of the ceramic powder 12.

The aluminum film 13 is to prevent separation of the ceramic powder 12, and is melted and alloyed with the internal electrode 20 when the internal electrode 20 is formed. The ceramic powder is utilized as a material of far-infrared radiation, but any substance to radiate far-infrared is possible.

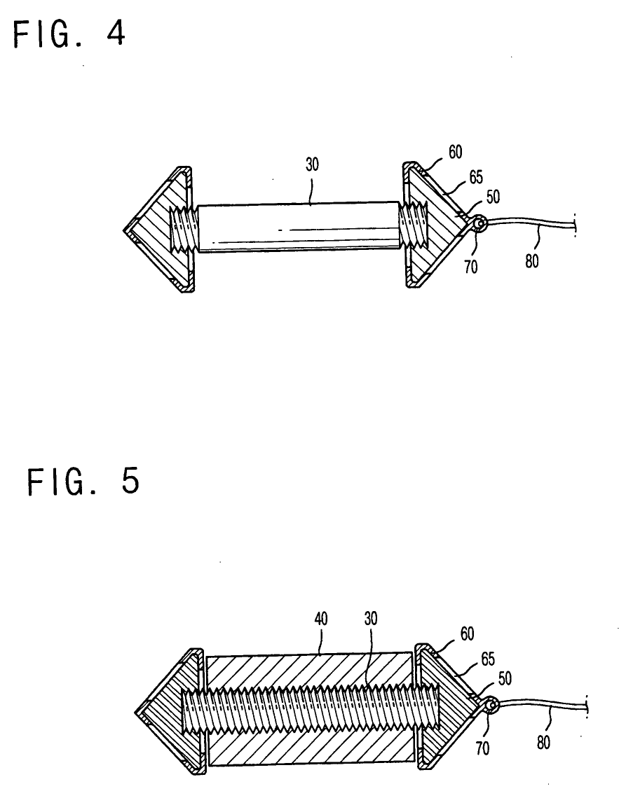

The internal electrode 20 formed on the core rod 10 may be machined to have a desired shape, for example, a rod member 30 as shown in FIG. 2, such that the internal electrode 20 generates an electromotive force and the core rod 10 radiates an electromagnetic wave.

The moisture contained in the fuel is reduced by the electromotive force and the electromagnetic wave produced from the apparatus. Accordingly, the reduction of the water contained in the fuel is maintained is a constant amount of hydrogen generation to improve the efficiency of fuel and engine.

Preferably, the internal electrode 20 is formed of any one of zinc alloy, aluminum alloy and magnesium alloy.

Although the rod member 30 is described and shown herein to have a rod shape, various shapes may be applied to the internal electrode 20.

### Embodiment 2

Referring to FIG. 3, the combustion-efficiency improving apparatus is adapted to be immerged into a fuel tank of an internal combustion. The apparatus includes a core rod 10 having a ceramic powder 12 coated or impregnated on an outer periphery of a silver alloy 11, and an aluminum alloy cladding the ceramic powder 12; an internal electrode 20 enclosing an outer periphery of the core rod 10 for creating a potential difference through shifting of electrons between the internal electrode and fuel; and an external electrode 40 formed on an outer periphery of the internal electrode 20.

The core rod 10 the and internal electrode 20 are substantially identical with those of the first embodiment, except that the ceramic powder 12 is coated or impregnated on or in a body of the external electrode, with the external electrode 40 being formed of a magnesium alloy. Accordingly, the detailed description of the core rod 10 and the internal electrode 20 will be omitted herein.

Preferably, when the external electrode 40 is formed on the rod member 30, a female threaded hole is formed in the external electrode 40, and a male threaded portion is formed on the rod member 30, as shown in FIG. 3, so that the rod member 30 is fastened with the external electrode 40.

Alternatively, the rod member 30 may be coupled to the external electrode 40 through insertion or melting method.

### Embodiment 3

Referring to FIG. 4, the combustion-efficiency improving apparatus is adapted to be immerged into a fuel tank of an internal combustion. The apparatus includes a core rod 10 having a ceramic powder 12 or impregnated on an outer periphery of a silver alloy 11, and an aluminum alloy cladding the ceramic powder 12; an internal electrode 20 enclosing an outer periphery of the core rod 10 for creating a potential difference through shifting of electrons between the internal electrode and fuel; and a lateral electrode 50 formed on both ends of the core rod 10 and the internal electrode 20.

The core rod 10 and the internal electrode 20 are substantially identical with those of the first embodiment, and so the detailed description thereof will be omitted herein. Preferably, the lateral electrode 50 is formed of any one of zinc alloy, aluminum alloy and magnesium alloy.

Preferably, the lateral electrode 50 is formed in a conical shape. A female threaded portion is formed in an inside of the lateral electrode, so that the lateral electrode is threadedly fastened with the rod member 30. Alternatively, the rod member 30 may be coupled to the lateral electrode 50 through insertion or welding method to increase a fastening force.

Although the lateral electrode 50 is described and shown herein to have a conical shape, any shape may be possible to enlarge a contact area with the water contained in the fuel.

Preferably, when the lateral electrode 50 is formed on the rod member 30, a female threaded hole is formed in the lateral electrode 50, and a male threaded portion is formed on the rod member 30, as shown in FIG. 4. Alternatively, the rod member 30 may be coupled to the lateral electrode 50 through an insertion or a melting method.

### Embodiment 4

Referring to FIG. 5, the combustion-efficiency improving apparatus is adapted to be immerged into a fuel tank of an internal combustion. The apparatus includes a core rod 10 having a ceramic powder 12 coated or impregnated on an outer periphery of a silver alloy 11, and an aluminum alloy cladding the ceramic powder 12; an internal electrode 20 enclosing an outer periphery of the core rod 10 for creating a potential difference through shifting of electrons between the internal electrode and fuel; an external electrode 40 formed on an outer periphery of the internal electrode 20; and a lateral electrode 50 formed on both ends of the core rod 10 and the internal electrode 20.

The internal electrode 20, the external electrode 40 and the lateral electrode 50 are substantially identical with those of the above embodiments, except that the core rod 10 consists of three electrodes.

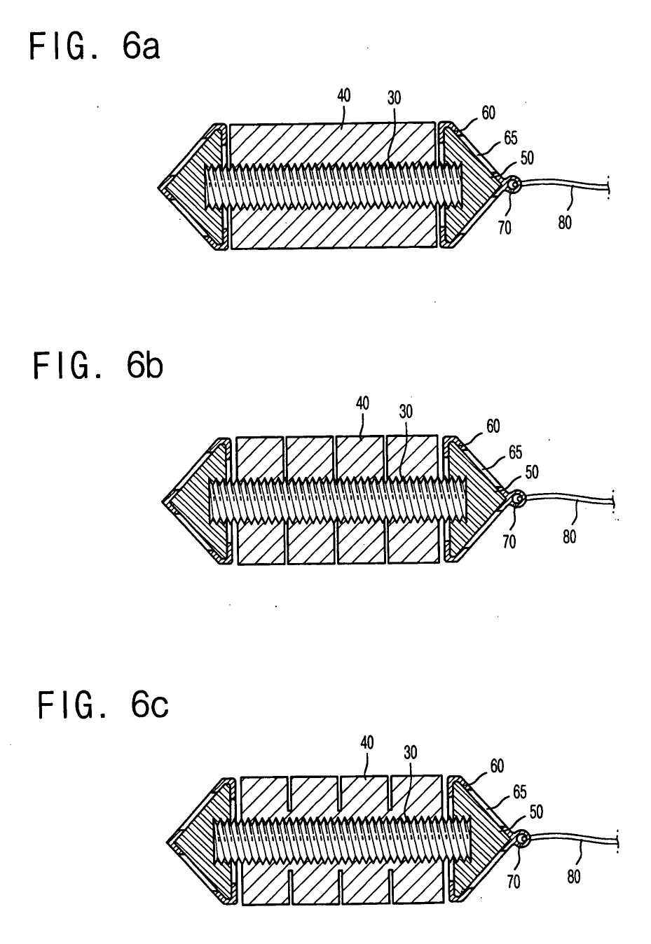

As shown in FIG. 5, the external electrode 40 may be formed to have a cross sectional area smaller than that of the lateral electrode 50, or, as shown in FIG. 6a, may be formed to have the same cross sectional area as that of the lateral electrode 50.

Also, in order to increase the contact area between the external electrode 40 and the fuel, several housings are consecutively arranged on the rod member 30, or a plurality of convex or concave portions are formed on the housing, in the course of forming the external electrode 40, as shown in FIGS. 6b and 6c.

As shown in FIG. 6b, preferably, when the external electrodes 40 are consecutively arranged on the rod member 30, a gap between the external electrodes is minimized so that about three or four external electrodes can be formed. As shown in FIG. 6c, preferably, about three or four convex and concave portions are formed on the external electrode.

### Embodiment 5

An insulating member 60 is formed on both ends of the lateral electrode 50 having the same structure as that of the first to fourth embodiments. One end of a lead wire 80 is connected to a ring 70 provided to the insulating member 60, and the other end thereof is connected to a cap (not shown) of a fuel tank.

The insulating member 60 is to insulate the electrode by shielding an electric charge generated when the apparatus is in contact with the fuel tank, and also is to damp an impact force generated when the apparatus is in contact with the fuel tank. Preferably, the insulating member is made of a material that is not chemically reacted with the fuel.

When the apparatus immersed into the fuel tank is repaired or replaced, the insulating member 60 is applied with a pulling force by the lead wire 80 connected to the insulating member. Therefore, the insulating member is formed of a material that can minimize deformation due to temperature or external load.

In addition, the insulating member 60 is provided on an outer periphery thereof with various patterns. In particular, the outer periphery of the insulating member 60 is formed with a plurality of holes 65 to enlarge a contact area between the lateral electrode 50 and the fuel.

The lead wire 80 is also to increase an amount of hydrogen generation of the water contained in the fuel.

Of course, the ring 70 and the lead wire 80 may be applied to the apparatus of the second and third embodiments.

Operation of the apparatus according to the present invention will now be described in detail.

If the combustion-efficiency improving apparatus having the structure shown in FIGS. 2 through 6 is inserted into the fuel tank of the internal combustion or boiler, electrons are shifted in an interface between the electrodes 20, 40 and 50 of the apparatus and the fuel to create the potential difference. Therefore, resonance is produced in the fuel by the core rod 10.

At this time, the potential difference created in the electrodes 20, 40 and 50 are based on the Nernst Equation. For example, it is well known that if a partial pressure of hydrogen is 1 bar and a temperature of 25° C., when a pair of electrodes having a metallic potential of below −0.6 V are contacted with the water, the hydrogen is reduced at a sufficient speed.

The water contained in the fuel is electrolyzed by the electromotive force generated from the core rod 10 and the electrodes 20, 40 and 50 so as to produce the reduction potential. Therefore, significant hydrogen is produced from the water contained in the fuel, thereby mixing the fuel with the hydrogen to improve the combustion efficiency.

Molecular activity between the fuel atoms is accelerated by the electromagnetic wave generated from the core rod 10 of the apparatus to produce the resonance and thereby to generate thermal energy in molecules.

In addition, the impact load is absorbed through the insulating member 60, with the apparatus being immersed into the fuel tank. The apparatus may be repaired or replaced by using the lead wire 80 connected to the ring 70.

As the above description, according to the combustion-efficiency improving apparatus for the internal combustion engine, the reduction potential of the water contained in the fuel may be achieved by the electromotive force and the electromagnetic waves generated from the apparatus. Therefore, the present invention may improve the combustion efficiency of the fuel to save the fuel and minimize smoke.

The forgoing embodiment is merely exemplary and is not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

1-10. (canceled)

11. A combustion-efficiency improving apparatus immerged into a fuel tank of an internal combustion, the apparatus comprising:
a core rod having a ceramic power coated or impregnated on an outer periphery of a silver alloy and an aluminum alloy cladding the ceramic power; and
an internal electrode enclosing an outer periphery of the core rod for creating a potential difference through shifting of electrons between the internal electrode and fuel; and wherein
a reduction potential of water contained in the fuel is achieved by an electromotive force and electromagnetic waves are generated from the core rod and the internal electrode.

12. The apparatus as claimed in claim 11, wherein the internal electrode is formed of any one of zinc alloy, aluminum alloy and magnesium alloy.

13. A combustion-efficiency improving apparatus immerged into a fuel tank of an internal combustion, the apparatus comprising:
a core rod having a ceramic power coated or impregnated on an outer periphery of a silver alloy and an aluminum alloy cladding the ceramic power;
an internal electrode enclosing an outer periphery of the core rod for creating a potential difference through shifting of electrons between the internal electrode and fuel; and
an external electrode formed on an outer periphery of the internal electrode; and wherein
a reduction potential of water contained in the fuel is achieved by an electromotive force and electromagnetic waves are generated from the core rod and the electrodes.

14. The apparatus as claimed in claim 13, wherein the external electrode is formed of a magnesium alloy.

15. The apparatus as claimed in claim 13, wherein the external electrode is formed by impregnating the ceramic power in a body thereof.

16. A combustion-efficiency improving apparatus immerged into a fuel tank of an internal combustion, the apparatus comprising:
a core rod having a ceramic power coated or impregnated on an outer periphery of a silver alloy and an aluminum alloy cladding the ceramic powder;
an internal electrode enclosing an outer periphery of the core rod for creating a potential difference through shifting of electrons between the internal electrode and fuel; and
a lateral electrode formed on both ends of the core rod and the internal electrode; and wherein
a reduction potential of water contained in the fuel is achieved by an electromotive force and electromagnetic waves are generated from the core rod and the electrodes.

17. The apparatus as claimed in claim 16, wherein the lateral electrode is formed of any one of zinc alloy, aluminum alloy and magnesium alloy.

18. A combustion-efficiency improving apparatus immerged into a fuel tank of an internal combustion, the apparatus comprising:
a core rod having a ceramic power coated or impregnated on an outer periphery of a silver alloy and an aluminum alloy cladding the ceramic power;
an internal electrode enclosing an outer periphery of the core rod for creating a potential difference through shifting of electrons between the internal electrode and fuel;
an external electrode formed on an outer periphery of the internal electrode; and
a lateral electrode formed on both ends of the core rod and the internal electrode; and wherein
a reduction potential of water contained in the fuel is achieved by an electromotive force and electromagnetic waves are generated from the core rod and the electrodes.

19. The apparatus as claimed in claim 18, wherein an insulating member is formed on the lateral electrode to insulate the lateral electrode by shielding an electric charge generated and to damp an impact force generated when the apparatus is in contract with the fuel tank.

20. The apparatus as claimed in claim 19, wherein the insulating member is provided with a ring, and one end of a lead wire is connected to the ring and an other end of the lead wire is connected to a cap of the fuel tank.
